(19) United States
(12) Patent Application Publication
(10) Pub. No.: US 2018/0042211 A1
(43) Pub. Date: Feb. 15, 2018

(54) DEVICE FOR MONITORING AND CATCHING INSECTS OF THE CULICIDAE POPULATION

(71) Applicants: Stefano ZAMBONI, Forli' (FC) (IT); Gregorio GENTILE, Bologna (BO) (IT); C.A.A. "GIORGIO NICOLI" S.R.L., Crevalcore (BO) (IT); IMOLADISINFESTAZIONI Dl MAGNANI MAURIZIO, Imola - Bologna (IT)

(72) Inventors: Stefano ZAMBONI, Forli' (FC) (IT); Gregorio GENTILE, Bologna (BO) (IT); Roberta COLONNA, Predappio - (FC) (IT); Maurizio MAGNANI, Imola (BO) (IT)

(21) Appl. No.: 15/553,428

(22) PCT Filed: Feb. 22, 2016
(86) PCT No.: PCT/IT2016/000045

§ 371 Date: Aug. 24, 2017

(30) Foreign Application Priority Data
Feb. 25, 2015 (IT) 102015000006939

(51) Int. Cl. A01M 1/02; A01M 1/10; A01M 1/06

(52) U.S. Cl. CPC A01M 1/023; A01M 1/026; A01M 1/06; A01M 1/106; A01M 1/04

(57) ABSTRACT

A device for monitoring and catching insects from the culicidae population, including a first container with first elements for attracting the insects; a second container, positioned inside the first container, and resting on it by a plurality of tie rods, an open upper base and a lower base, the second container provided with a second plurality of elements for attracting insects; a device for generating air flow, which is positioned at the lower base of the second container to suck in insects dose to the device, from the outside towards the inside of the second container through the open upper base; and a perforated bag, positioned at the open upper base, which extends to the device for generating air flow, for monitoring and catching insects sucked inside.

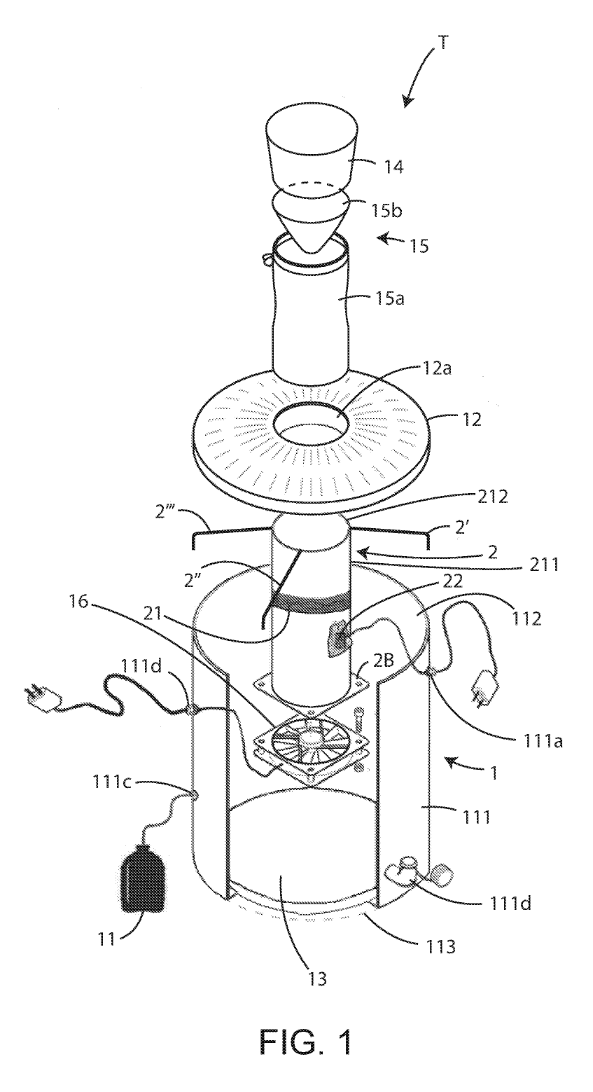

This invention relates to a device for monitoring and catching insects from the culicidae population.

In greater detail, the invention relates to a device of the type called, studied and made more specifically for catching insects from the family Culicidae, that is the Aedes albopictus, commonly known as the tiger mosquito, but it may also be used for the species Culex pipiens, Anopheles spp, Aedes koreicus, Aedes japonicus, Aedes aegypti and for the species which have the host chemical seeking mechanisms and/or the oviposition site in common with the Aedes albopictus.

The description below relates to the specimens from the Aedes albopictus species, but it is quite apparent how the same should not be considered limited to this species.

As is well known, tiger mosquitos are currently widespread also in urban centres, especially in the early morning hours and in the late afternoon, disturbing and biting the population and causing health problems, given that these mosquitos are capable of transmitting pathogens which may cause illness—even serious illness—in humans.

Moreover, these mosquitos require water to complete their development cycle, more specifically they colonise standing water such as water traps for rainwater runoff and urban and residential street furniture which accidentally collects rainwater, such as e.g. flowerpot saucers, drums and the like.

The eggs laid on the vertical walls of the containers hatch in contact with the water, thus freeing the larvae which then give rise to the adult individuals in just a few days.

After mating, the females are capable of laying the eggs after having the “blood meal” which gives the mosquito the protein substances required to mature the eggs.

The meeting between the male individual and female individual is favoured by the sound generated by the beating wings of the female. This signal attracts the males which, with the females, form a mating swarm where different specimens of males and females fly and mate.

There are currently different systems for containing the problem of mosquito proliferation.

Modern control systems both within the public and private scope are essentially based on larvicide control with the removal of the outbreaks and the application of larvicide products in the standing water that cannot be removed.

Nevertheless, although this method is effective, it is insufficient because it is not adequately widespread and extensive throughout the urban territory.

Furthermore, devices, monitoring and catching traps are used in Culicidae control, these devices serving to determine the presence/absence and infestation level of a specific insect in an area.

These devices are designed to collect important information, also for improving the control timeframes and strategies underway, by measuring and identifying the suitable time for any abatement treatments when the presence reaches the tolerability limitations of the population.

In addition to this use, which targets specialised entomologies and/or technicians, monitoring and catching traps may also play a complementary role to the larvicide treatments in reducing the mosquito population when they are used within the private realm, such as for example gardens.

There are also attractant traps currently on the market which may provide valid assistance in containing adult individuals when they are used in combination with larvicide products.

The object of these domestic attractant traps is to catch the female mosquitos alone which, after mating with the male, are in search of the host on which to have the blood meal required to provide the proteins which are necessary for maturing the eggs.

An example of this type of attractant trap is represented by European Patent Application EP 1745697.

However, these existing attractant traps are not designed to also catch male individuals and female individuals in other stages of their life.

In light of the above, it is thus the object of this invention to make an attractant trap which not only can catch the female tiger mosquitos in search of the blood meal, but also the ones in search of a suitable site for laying the eggs, and the females in search of the male for mating and also the males of the family.

It is a further object of this invention to make an attractant trap which is also effective for other species in the family Culicidae, such as Culex pipiens, Anopheles spp, Aedes koreicus, Aedes japonicus, Aedes aegypti.

Thus, a specific object of this invention is a device for monitoring and catching insects from the culicidae population, comprising: a first container provided with a first plurality of elements for attracting the insects; at least a second container, positioned inside the first container, and resting on it by means of a plurality of tie rods, comprising an open upper base and a lower base, the second container being provided with a second plurality of elements for attracting the insects; at least one device for generating an air flow, which is positioned at the lower base of the second container so as to suck in the insects close to the device, from the outside towards the inside of the second container through the open upper base; and at least one perforated bag, positioned at the open upper base, which extends to the device for generating an air flow, for monitoring and catching the insects sucked inside the device.

Further according to the invention, the first plurality of attractant elements comprises: a first olfactory attractant for attracting the female insects ready to oviposit; a first visual attractant for attracting the male and female insects; and the second plurality of attractant elements comprises a second olfactory attractant for attracting the females ready to have a blood meal; and a sound attractant for attracting the males ready for mating.

Preferably according to the invention, the device comprises a further olfactory attractant for attracting the insects belonging to the species Culex pipiens, Anopheles spp, Aedes koreicus, Aedes japonicus, Aedes aegypti.

Moreover according to the invention, the first container has a lateral surface, which is preferably cylindrical in shape, on which a plurality of through holes is made for the electrical, liquid and/or gaseous supply of the device, an open upper base on which a lid is positioned, made of a breathable white fabric and in which a central hole is made, and a closed lower base.

Further according to the invention, the first visual attractant consists of the colour black of the lateral surface of the first container.

Preferably according to the invention, the further olfactory attractant is a device for dispensing gaseous carbon dioxide, which introduces the carbon dioxide into the first container through at least one hole of the plurality of through holes.

Moreover according to the invention, the first olfactory attractant is a solution comprising water and an organic compound of natural origin; the lower base of the first container contains the solution; and the solution can be introduced into the first container through one of the holes of the plurality of through holes.

Further according to the invention, the second container has a lateral surface, which is preferably cylindrical in shape, on which a housing is obtained; the device further comprises a release system in which the second chemical olfactory attractant is absorbed, the release system being positioned in the housing; and the second chemical olfactory attractant is a compound of substances which simulate the group of chemical substances given off in human skin perspiration and breathing.

Preferably according to the invention, a housing for the sound attractant is obtained on the lateral surface of the second container; and the sound attractant is an electronic device which reproduces the sound generated by the beating wings of the females ready to mate and is electrically powered by means of a cable passing through at least one hole of the plurality of through holes.

Moreover according to the invention, a black external collector element for conveying the insects inside the device is positioned on the open upper base of the second container, the external collector element passing through the central hole of the lid.

Further according to the invention, the at least one perforated bag comprises a first part, having a cylindrical shape, accommodated inside the second container, which first part extends from the open upper base to the lower base of the second container, and a second part, having a truncated cone shape, accommodated inside the first part and coupled to the first part at the upper base of the second container: and the external collector element secures the first and second part to the open upper base of the second container.

Preferably according to the invention, the device for generating an air flow is a fan powered through an electric cable passing through at least one hole of the plurality of through holes. This invention will now be described, by way of example and without limiting the scope of it, according to its preferred embodiments, with reference to the accompanying drawing which shows an exploded view of a device for monitoring and catching insects from the culicidae population, more specifically tiger mosquitos, the object of the invention.

In reference to the accompanying drawing, the device for monitoring and catching insects from the culicidae population, more specifically tiger mosquitos, the object of the invention is depicted by an attractant trap T comprising a plurality of attractant elements of the visual, olfactory and sound type capable of attracting and trapping inside it all insects belonging to the family Culicidae, more specifically of the species Aedes albopictus.

These insects may be divided into the following groups: male individuals, female individuals ready for mating, female individuals which require the blood meal and female individuals about to oviposit.

More specifically, the attractant trap T comprises a first container 1, which is cylindrical in shape, capable of accommodating all the other construction elements of the attractant trap T.

The first cylindrical container 1 has a lateral surface 111, an open upper base 112 and a closed lower base 113 to allow the attractant trap T to be rested on a surface.

More specifically, the lateral surface 111 depicts a first attractant element of the visual type, more specifically coloured, because it has a black pigment.

The black is characterised by an increased attractant capacity both towards females and males of Aedes albopictus because in the South-East Asian forests where the tiger mosquito originates, it seeks cavities of trees and natural recesses to lay eggs and as a shelter, and therefore the colour black simulates a natural cranny.

Moreover, a plurality of through holes 111a, 111b, 111c, 111d for the electrical and liquid supply of the attractant trap T are made on the lateral surface 111.

A lateral surface provided with one through hole alone may also be used.

More specifically, the through holes 111a and 111b serve as a passageway for electrical supply cables for elements contained inside the first cylindrical container 1 which will be described in detail below; the through hole 111c is normally closed by a cap. In a specific embodiment, it serves as a passageway for the supply of a further olfactory attractant which will be described in detail below; the through hole 111d serves as passageway for the supply of a solution which will be described in detail below.

With regard to the further olfactory attractant present in a specific embodiment alone, it is depicted by a device 11 for dispensing gaseous carbon dioxide, which introduces the carbon dioxide into the first cylindrical container 1.

The gaseous carbon dioxide does not have particularly effective attractants towards the species Aedes albopictus but it is one of the chemical signals which is most followed in the search for the host by other mosquito species, such as the Culex pipiens.

The open upper base 112 is closed by a lid 12, which is made of a breathable white fabric.

A central hole 12a is made in the lid 12, designed to introduce further elements of the attractant trap T, as will be described in detail below.

The lower base 113 is an impermeable container and accommodates a solution 13, up to the through hole 111d, comprising water and an additive chemical substance, which serves as first chemical olfactory attractant.

More specifically, the additive chemical substance is of natural organic origin and may be selected from different substances, all characterised—at a predetermined concentration—by a strong olfactory attractant capacity towards the female mosquitos which have already had the blood meal and, once the eggs have matured, are in search of a site for ovipositing.

Substances having this important feature are for example plant macerals of leaves and/or grass, such as the oak bark, or Quercus Spp, maceral and the Bacillus thuringiensis variety israelensis-based solution.

The Bacillus thuringiensis variety israelensis is a bacteria known to be a larvicide for mosquito larvae but it also has a strong olfactory attractant capacity towards female mosquitos in search of a location for ovipositing.

Therefore, the additive chemical substance simulates the presence of a suitable place for laying the eggs and is introduced into the first cylindrical container 1 through the through hole 111d which can be capped using a closing element.

The attractant trap T further comprises a second container 2, which is cylindrical in shape, which is concentric compared to the first cylindrical container 1 and has a smaller diameter compared to the diameter of the first cylindrical container 1, which is provided with a second chemical olfactory attractant and a sound attractant.

The second container 2 is provided with a plurality of tie rods, more specifically a first 2′, a second 2″ and a third 2′″ tie rod by means of which the second container 2 is attached to the first container 1.

More specifically, the second cylindrical container 2 has a lateral surface 211, an open upper base 212 for accommodating elements which will be described in detail below, and a lower base 213.

A housing is made on the lateral surface 211, housing which occupies the whole lateral surface 211 or only part of it, designed to accommodate a release system in which the second chemical olfactory attractant 21 is absorbed.

More specifically, the release system is a slow-release absorbent material which releases scented substances contained in it, following the passage of an air current, as will be described in detail below.

The second chemical olfactory attractant 21 is composed of substances which simulate the group of chemical substances given off by human skin perspiration and breathing, such as butyric acid and/or propionic acid and/or formic acid and/or lactic acid and/or caproic acid, and is used to attract mainly female tiger mosquitos which are searching for the host on which to have the blood meal.

A housing for a sound attractant 22 is also obtained on the lateral surface 211.

The sound attractant 22 is an electronic device which reproduces the typical sound generated by the beating wings of the females ready to mate and is used to attract the males.

The electronic device is opportunely calibrated to emit a sound characterised by a frequency and volume capable of replicating the beating wings specifically of the female tiger mosquito.

The presence of males trapped inside the first cylindrical container 1 favours the release of a fourth chemical additive represented by the chemical substances given off naturally by the males and which therefore attract the females ready for mating.

An external collector element 14, opportunely shaped to adjust the flow of suction, which passes through the central hole 12a of the lid 12, is positioned at the upper base 212 of the second cylindrical container 2.

The external collector element 14 is black, designed to convey the insects inside the attractant trap T and to support a perforated tulle bag 15.

The perforated tulle bag 15 comprises a first part 15a and a second part 15b.

The first part 15a, having a cylindrical shape, adheres to the inner surface of the inner cylinder 2, and a second part 15b, having a truncated cone shape, is accommodated inside the first part 15a.

The external collector element 14 is introduced in the upper base 212 of the second cylindrical container 2 so as to stop the bag 15 inside the second cylindrical container 2 and to partially come out of the central hole 12a of the lid 12.

A suction fan 16 which generates an air vortex which sucks the mosquitos into the attractant trap T is positioned at the lower base 213 of the second cylindrical container 2. The suction fan 16 is electrically powered through a cable passing through the through hole 111b made on the lateral surface 111 of the external cylinder 1.

The operation of the attractant trap T described above is as follows.

When a user intends using the attractant trap T to attract mosquitos, he/she initially electrically powers the attractant trap T by connecting it to the power grid using the cables of the suction fan 16 and of the sound attractant 22.

The suction fan 16 generates a depression and therefore causes a suction of air through the external collector element 14.

The sucked in external air is directed towards the lower base 113 of the first cylindrical container 1 and from here, striking against the inner lateral surface of the lower base 1, flows upwards to be output through the lid 12.

In this path, the air transfers the volatile substances contained in the solution 13 and in the second chemical olfactory attractant 21 to the outside, and comes into contact with the carbon dioxide which, in a specific embodiment, flows out of the device 11 for dispensing gaseous carbon dioxide, so as to diffuse these attractant substances outside the attractant trap T.

These substances diffused externally, combined with the call of the sound emitted by the sound attractant 22 and combined with the call of the visual attractant 111, contribute to attracting the mosquitos which, as soon as they move within the vicinity of the external collector element 14, are sucked in by the air vortex generated by the fan 16 and end up in the second part 15b of the bag 15 to remain trapped in it.

Moreover, the males trapped in the attractant trap T produce natural chemical substances which serve as an attractant for the females ready for mating.

As is apparent from the description above, the attractant trap T comprises a plurality of chemical, sound and visual attractants which contribute to attracting and then trapping mainly all the individuals of the species Aedes albopictus and secondly the individuals of the species Culex pipiens, Anopheles spp, Aedes koreicus, Aedes japonicus, Aedes aegypti.

This invention is described by way of example only, without limiting the scope of application, according to its preferred embodiments, but it shall be understood that the invention may be modified and/or adapted by experts in the field without thereby departing from the scope of the inventive concept, as defined in the claims herein.

1-12. (canceled)

13. A device for monitoring and catching insects from the culicidae population, comprising:
a first container provided with a first plurality of elements for attracting insects;
at least a second container, positioned inside the first container, and resting on it with a plurality of tie rods, comprising an open upper base and a lower base, said second container being provided with a second plurality of elements for attracting the insects;
at least one device for generating an air flow, which is positioned at the lower base of said second container so as to suck in the insects close to said device, from the outside towards the inside of said second container through said open upper base; and
at least one perforated bag, arranged in correspondence of said open upper base, which extends to said device for generating an air flow, for monitoring and catching the insects sucked inside the device.

14. The device according to claim 13, wherein said first plurality of attractant elements comprises:
a first olfactory attractant for attracting the female insects ready to oviposit;
a first visual attractant for attracting the male and female insects; and
wherein said second plurality of attractant elements comprises:
a second olfactory attractant for attracting the females ready to have a blood meal; and
a sound attractant for attracting the male insects ready for mating.

15. The device according to claim 13, further comprising an olfactory attractant for attracting the insects belonging to the species Culex pipiens, Anopheles spp, Aedes koreicus, Aedes japonicus, Aedes aegypti.

16. The device according to claim 13, wherein said first container has a lateral surface, which is preferably cylindrical in shape, on which a plurality of through holes is made for the electrical, liquid and/or gaseous supply of the device,
an open upper base on which a lid is positioned, made of a breathable white fabric and in which a central hole is made, and
a closed lower base.

17. The device according to claim 14, wherein said first visual attractant consists of the colour black of the lateral surface of said first container.

18. The device according to claim 15, wherein said further olfactory attractant is a device for dispensing gaseous carbon dioxide, which introduces said carbon dioxide into the first container through at least one hole of said plurality of through holes.

19. The device according to claim 15, wherein
said first olfactory attractant is a solution comprising water and an organic compound of natural origin;
said dosed lower base of said first container contains said solution; and
said solution can be introduced into said first container through one of said holes of said plurality of through holes.

20. The device according to claim 13, wherein
said second container has a lateral surface, which is cylindrical in shape, on which a housing is obtained;
said device further comprises a release system in which said second chemical olfactory attractant is absorbed, the release system being positioned in said housing; and
said second chemical olfactory attractant is a compound of substances which simulate the group of chemical substances given off in human skin perspiration and breathing.

21. The device according to claim 13, wherein
a housing for said sound attractant is obtained on the lateral surface of said second container; and
said sound attractant is an electronic device which reproduces the sound generated by the beating wings of the female insects ready to mate and is electrically powered by a cable passing through at least one hole of said plurality through holes.

22. The device according to claim 14, wherein a black external collector element for conveying the insects inside the device is positioned on said open upper base of said second container, the external collector element passing through said central hole of said lid.

23. The device according to claim 13, wherein
said at least one perforated bag comprises:
a first part, having a cylindrical shape, accommodated inside said second container, which first part extends from said open upper base to said lower base of said second container, and
a second part, having a truncated cone shape, accommodated inside said first part and coupled to said first part at said upper base of said second container; and
said external collector element secures said first and second part to said open upper base of said second container.

24. The device according to claim 13, wherein said device for generating an air flow is a fan powered through an electrical cable passing through at least one hole of said plurality of through holes.
